(19) United States
(12) Patent Application Publication
(10) Pub. No.: US 2010/0170838 A1
(43) Pub. Date: Jul. 8, 2010

(54) Vessel for Magnetically Treating A Fluid

(76) Inventor: Michael R. Falcone, San Jose, CA (US)

Correspondence Address: Richard E. Ballard, 6812 Leyland Park Drive, San Jose, CA, 95120, US

(21) Appl. No.: 12/034,202

(22) Filed: Feb. 20, 2008

(51) Int. Cl. B03C 1/02; B65D 77/00

(52) U.S. Cl. 210/222; 206/216

(57) ABSTRACT

A vessel for magnetically treating a fluid is generally cylindrical, having an open end and a bottom end closed by a wall; and a magnet disposed at the bottom wall of the vessel. The fluid may be a beverage in a container such as a bottle or a can which fits into the open top end of the vessel. Or, the vessel may hold the fluid. The vessel may be formed of plastic or neoprene. The magnet may be a neodymium magnet in the form of a disc. The magnet may be disposed in the vessel with its north pole facing up, may be removable so that its orientation can be changed, may be disposed on an interior or exterior surface of a bottom wall of the vessel, and may be embedded in the bottom wall. The vessel may function as a bottle holder, a cup holder, or a cup.

### TECHNICAL FIELD OF THE INVENTION

The invention relates to treating fluids, such as beverages, with magnetism.

### BACKGROUND OF THE INVENTION

Magnets and magnetic energy have been used for pain relief, health, and wellness for thousands of years. Our ancestors used a natural occurring magnetic mineral called Lodestone to treat aliments, relieve arthritis pain, and promote energy for a forthcoming hunt or battle. Unfortunately, modern man lost this special knowledge of bio-magnetics in his transition to modern times.

Life was created in a sea of magnetism. Even though we have always been surrounded by this unseen magnetic earth force many researchers were unaware of the key role magnetism played in our health and well being. In fact, we now know that without magnetism there would be no life at all on earth.

Magnets and magnetic therapy can provide energy, reduce pain caused by arthritis or an injury, increase health and wellness, treat a multitude of disorders, relieve pain, and increase energy.

For example, treating pain or an disorder with a magnetic shower head and Chlorine free water, magnetically altered water, or a health magnet with magnetic therapy may be a better treatment choice than many drugs and prescription with their accompany side-effects. Magnetic therapy has no known side effects. Magnets, magnetism, and magnetic energy are natural and side-effect free alternative treatments for arthritis pain.

Various patents, such as may be discussed hereinbelow, disclose the use of magnets with beverages.

### RELATED PATENTS AND PUBLICATIONS

U.S. Pat. No. 7,100,495, incorporated by reference herein, discloses a method and apparatus of treating wine to improve the wine's taste. This is accomplished by treating the wine with a magnetic field formed by one or more magnets, preferably at least two magnets. These magnets are positioned with one magnet at the base of a container that is holding the wine and another magnet at the top of the container.

U.S. Pat. No. 7,107,894, incorporated by reference herein, a device to magnetically treat beverages by fastening to a beverage container. The device is preferably a magnetic fastener constructed and arranged to be attached to the neck of a wine bottle. The magnetic fastener comprises two semi-cylindrical halves, a spring mechanism connecting the semi-cylindrical halves and a plurality of magnets. Each semi-cylindrical half may preferably have a fastening end and a grasping end, wherein each fastening end may contain three columns of magnets which may preferably be substantially evenly spaced in the fastening end of the semi-cylindrical half. The magnets may preferably be aligned so that the polarity runs through the device, wherein the north pole is located at one end and south pole is located at the other end.

U.S. Pat. No. 6,959,640, incorporated by reference herein, discloses a device for magnetically treating materials includes a base, and at least one magnet carried by the base to generate a magnetic field within the material. In some embodiments, the material may be within a container, and the magnetic field may be generated within the container to magnetically treat the material. The material may be a beverage and the magnetic treatment may enhance the flavor of the beverage, or may be an emollient and the magnetic treatment may change a characteristic of the emollient. The device may include a base, a plurality of tubular members extending upwardly from the base and arranged in spaced-apart relation to receive the material, and at least one magnet within each of the tubular members to generate a magnetic field within the material.

U.S. Pat. No. 6,287,614, incorporated by reference herein, discloses a method and apparatus for improving the organoleptic properties of various alcoholic beverages by reducing the sensory perception of acids and tannins in wine, brandies, sherries, cognacs, spirits, beer, tea, coffee and fruit juice, including but not limited to any alcoholic beverages that have been aged in wood barrels or had the addition of wood or wood chips added to improve or enhance the flavor. The product to be treated can be either placed upon, inside or channeled through a magnetic field produced by permanent magnets, strong enough to achieve the desired results. The minimum gauss strength of said magnets should be strong enough to achieve said results depending upon whether the liquid to be treated is stationary, contained in a bottle, barrel or tank, or is moving through a pipe line during the manufacturing process.

U.S. Pat. No. 6,974,543, incorporated by reference herein, discloses a magnetic-energy-releasing molecular rearranging structure includes an amount of magnetic powder, which is molded into a magnetic member in the form of a ball, a mass, or a flat piece, and having magnetic-energy-releasing molecules, so that the member has magnetic lines that together with earth poles produce a radiated magnetic field. Superficial molecules of a solid body and a liquid, or air molecules in a limited space may be magnetized and rearranged using the magnetic-energy-releasing member, and molecules of a substance that is to be magnetized may be magnetized and rearranged through magnetic energy transmission from the magnetized molecules of the solid body, the liquid, or the air in the limited space to the substance.

U.S. Pat. No. 6,755,968, incorporated by reference herein, discloses a liquid magnetic processing unit that can activate a liquid flowing in a thick pipe and can perform water treatment. The liquid magnetic processing unit is mounted around the pipe in which the liquid flows and activates the liquid by magnetic force. The unit has one or more water treatment sections each having a band to be placed around the pipe and magnet housings which have the band inserted through them and that house a plurality of permanent magnets. The one or more water processing sections are covered with a case of a non-magnetic material.

U.S. Pat. No. 6,706,179, incorporated by reference herein, discloses a water magnetizer including a permeance member and a cooking recipient. The permeance member consists of two parallel disks spaced apart each other by a plurality of partitions located along the periphery of the disks, such that there is clearance between the two parallel disks. The permeance member is placed into the cooking recipient that is charged with water. Then, the cooling recipient is placed onto an electromagnetic heater. When the electromagnetic heater powers on, inner coils of the electromagnetic heater regularly vibrate at high frequency to change the direction of electric current and then induce a swirled magnetic field in the clearance. The water would be boiled by a lot of heat generated from electron movement in the induced magnetic field.

U.S. Pat. No. 6,440,302, incorporated by reference herein, discloses a portable water purifier of a type having a pitcher with a lower terminal wall and being divided vertically by a lateral partition into an upper compartment for holding raw water and a lower compartment for holding purified water, and a filter depending from the lateral partition into the lower compartment for purifying the raw water into the purified water. The improvement includes a base having a weight and replaceably supporting the pitcher thereon and acting as a coaster therefore, and a permanent magnet having a weight and encased throughout the base for delivering a concentrated and polarized magnetic charge through the lower terminal wall of the pitcher and into the purified water so as to polarize the purified water until its molecules are gradually rearranged from a normal agglomerated state into a more linear, organized, and substantially more permeable state that increases a body's ability to absorb and assimilate the purified water.

U.S. Pat. No. 6,390,319, incorporated by reference herein, discloses a beverage container volume is exposed to magnetic fields associated with a permanent magnet. A beverage container volume is exposed to a permanent magnet incorporated into a beverage container cap, bottom, collar, holder or overlayer.

U.S. Pat. No. 6,299,768, incorporated by reference herein, discloses a magnetic treatment apparatus for magnetically activating water. The apparatus includes an upstream connector, a housing, a downstream connector and a magnetic unit. The magnetic unit is accommodated within a magnetic treatment passage formed in the housing. The upstream connector and the downstream connector are provided with a water inlet passage and a water outlet passage, respectively. Both of the water passages are in communication with the magnetic treatment passage of the housing. The magnetic unit includes a plurality of magnet holding pipes extending along the magnetic treatment passage. Each of the magnet holding pipes hermetically contains a plurality of disk-shaped permanent magnets, so that water to be treated will not come into contact with the permanent magnets.

U.S. Pat. No. 5,932,096, incorporated by reference herein, discloses apparatus for removing magnetic material from a flowing fluid such as water by magnetic separation has a single set of electromagnets which are used with a plurality of magnetic filters for continuous magnetic separation operation alternately without obstructing the flow of the fluid being processed. A high-gradient magnetic filter arrangement which passes through a magnetic field generated by the magnets is made up of at least two magnetic filters separated by a watertight partition. When the fluid being processed is flowing through one of the magnetic filters, the other filter is removed from the flow of the fluid into a magnetic filter housing which is separated from the fluid flow through the magnetic filter by means of partitions. Backwashing of this other magnetic filter is carried out while purification of the fluid being processed by the former magnetic filter continues uninterrupted. Dummy magnetic filters are provided at the outer ends of the magnetic filter arrangement so that whichever of the magnetic filters is removed from the flow of the fluid being processed, the filter matrices do not leave the magnetic field formed by the plurality of magnets, and consequently the magnetic filters can be moved in and out of the magnetic field with a minimal driving force.

U.S. Pat. No. 5,891,332, incorporated by reference herein, discloses a method for purifying raw water taken from a raw water reservoir. The method includes the steps of subjecting the raw water to magnetic treatment, causing the magnetically treated water to flow through a filter medium in a first direction for purification of the treated water, and discharging the purified water into the raw water reservoir. The method further includes the steps of causing the magnetically treated water to pass through the filter medium in a second direction opposite to the first direction, and discharging the oppositely passing water into the raw water reservoir. The apparatus for realizing the above method includes a water intake assembly, a filter assembly and a water discharge assembly. A magnetic treatment device is mounted on the water intake assembly for subjecting the raw water to magnetic treatment. A switching device is operated to cause the magnetically treated water to flow through the filter assembly selectively in the first and second directions.

U.S. Pat. No. 5,873,486, incorporated by reference herein, discloses cup holders which are selectively mountable to a plurality of surfaces to hold cups and containers of beverages particularly in vehicles. The invention provides a holder having a plurality of selectable mounting means whereby the user may select that means most appropriate to the surface on which the holder is to be mounted. A cup holder having a plurality of selectable mounting means comprising a hook and loop fastener, an adhesive means and a magnetic means positioned on the bottom surface of the receptacle so as to be selectively engagable with a mounting surface and wherein the selective mounting means are positioned on the bottom surface in a stacked relationship in the order of the hook portion of the hook and loop fastener, the loop portion of the hook and loop fastener whereby the hook and loop portions are engaging, the adhesive means and the magnetic means, whereby the magnetic means provides a means for removably mounting the holder on a ferrous metal surface and is removable to expose the adhesive means whereby the holder is adhesively mountable to any surface, and the adhesive means being a part of the loop portion of the hook and loop fastener whereby the loop portion is adhesively fixable to a mounting surface and whereby the adhesive and the loop portion are removable to expose the hook portion of the hook and loop fastener whereby the holder is releasably mountable to a pile covered surface including the adhesively fixed loop portion.

U.S. Pat. No. 5,813,557, incorporated by reference herein, discloses a magnetized fluid vessel which includes a fluid container or conduit. First and second magnets are situated on opposite sides of the vessel wall and are encircled by a metallic band or collar. The vessel may have an open mouth defined by a rim. In one embodiment, magnets are suspended by hangers form a rim of a cup. The cup and magnets are received in an exterior container with a removable lid. Other embodiments include oxygen tanks, oxygen tubes and containers for intravenous liquids.

U.S. Pat. No. 5,804,068, incorporated by reference herein, discloses a fluid treatment device having fluid containment housing with a first containment region and a second containment region. The first and second containment regions are connected in fluid flow communication with one another by a generally narrow, elongate transfer channel that permits fluid to flow there through from one containment region to another while the fluid defines a natural vortex. Moreover, a generally powerful, polarized magnet is disposed about the transfer channel in order to deliver a concentrated, polarized magnetic charge into the transfer channel, thereby acting on the fluid flowing in the natural vortex through the transfer channel and polarizing it until the fluid molecules thereof are gradually rearranged from a normal agglomerated state into a more linear, organized and substantially more permeable state that will increase a body's ability to absorb and assimilate the fluid and obtain benefits therefrom.

U.S. Pat. No. 5,628,900, incorporated by reference herein, discloses a water purifier includes a filter having a cylindrical housing formed with a water inlet at one end and a water outlet at the other end and contains in the housing a ceramic layer consisting of granular ceramic heaped up in a layer, a magnetite layer consisting of broken pieces of magnetite heaped up in a layer and provided at least above or below the ceramic layer, and annular magnets provided above and below the ceramic layer in such a manner that these annular magnets coincide with each other in the sense of magnetic lines of force and that the direction of the magnetic lines of force is parallel to the direction of flow of water. Water molecules are activated while passing through the magnetic field produced by the annular magnets and the magnetite layers which are magnetized by the annular magnets.

U.S. Pat. No. 5,542,562, incorporated by reference herein, discloses a magnetized fluid vessel. The vessel includes a fluid container or conduit. First and second magnets are situated on opposite sides of the vessel wall and are encircled by a metallic band or collar. The vessel may have an open mouth defined by a rim. In one embodiment, magnets are suspended by hangers form a rim of a cup. The cup and magnets are received in an exterior container with a removable lid. Other embodiments include oxygen tanks, oxygen tubes and containers for intravenous liquids.

U.S. Pat. No. 5,522,992, incorporated by reference herein, discloses a device for the treatment of selected solutions wherein the device is a sealed container including a chemical mixture therein, at least one of the ingredients being magnetite.

U.S. Pat. No. 5,094,742, incorporated by reference herein, discloses a magnetic water conditioning shower arm disposed in a water circuit supplying a shower head terminating the water circuit, the device comprises magnetic elements disposed within a tubular pipe-like element for treatment of water flowing therethrough by magnetic lines of force. The shower arm is preferably disposed immediately before the shower head in the water circuit and can thus be easily retrofitted into existing shower apparatus as well as installed as part of an original shower apparatus. The shower arm is particularly useful for the treatment of water containing scale minerals which deposit on surfaces of a shower head and which often render such heads prematurely useless. Magnetic treatment of water containing scale minerals according to the invention and prior to contact of untreated water with a shower head inhibits scale formation caused by precipitation of calcium salts, magnesium salts and other mineral compounds, thereby extending the useful life of a shower head to that life normally expected.

U.S. Pat. No. 4,946,590, incorporated by reference herein, discloses a clamp-on magnetic water treatment device for minimizing hard precipitate scale and lime deposit in a fluid supply, especially a domestic water system, has a magnet array having two sections which clamp together over a non-ferromagnetic section of conduit in the water system. The array of magnets defines at least two pairs of magnetic poles of opposite polarity across the flow path for the water, whereby a magnetic field is produced defining flux lines directly perpendicular to the flow path, and the magnets in the array attract one another across the flow path. The magnets in the array also define magnetic poles of opposite polarity proceeding downstream along the flow path. However, the individual magnets in the array are all arranged such that their poles are directed toward and away from the conduit, and not longitudinally along the flow path. In this manner, the maximum field strength is obtained in a clamp-on device. An outer enclosure of ferromagnetic material confines lines of flux to high permeability materials, maximizing flux density at the area of the fluid flowing in the conduit.

U.S. Pat. No. 4,299,700, incorporated by reference herein, discloses a device for the magnetic treatment of water and other liquids, having a pair of concentric tubular casings which are spaced from each other so as to form an annular treatment chamber. The inner casing contains an elongated magnet having two or more longitudinally spaced poles, and the intermediate casing is made of a magnetic material which serves to concentrate the magnetic lines of force within the annular chamber. The inner casing is supported within the intermediate casing by means of elastic, non-magnetic sleeves which are positioned over opposite ends of the inner casing and compressed between it and the inner surface of the intermediate casing so that the treatment chamber is rendered fluid-tight. Pair of apertures are provided in the opposite ends of the inner casing to permit fluid to flow into and through the annular chamber. In order to prevent the magnet from shifting axially relative to the inner casing and to prevent the inner casing from shifting axially relative to the sleeves, the apertures are deformed inwardly and outwardly so as to form locking ears between the apertures and the magnet and sleeves, respectively. The ends of the inner casing are flared outwardly so as to prevent the sleeves from sliding off the inner casing and to impart additional compression to the sleeves.

U.S. Design Pat. No. D511,198, incorporated by reference herein, discloses an ornamental design for a magnetic treatment device for fluids.

U.S. Design Pat. No. D500,118, incorporated by reference herein, discloses an ornamental design for a magnetic treatment device for fluids.

US Publication No. 20070017924, incorporated by reference herein, discloses a thermally insulated beverage bottle holder that includes a sleeve constructed of flexible thermally insulating material having the general shape of a beverage bottle, the sleeve having a generally bottom cylindrical portion defining a first opening at the bottom first end thereof and an upper tapered portion that converges in size to define a second opening at the top second end thereof, whereby a beverage bottle can be inserted through the bottom first end of the sleeve with the top of the bottle exposed at the tapered top second end for access by a user to the contents of the beverage bottle. A securement member has one end thereof attached to or integral with one side of the sleeve and is removably attachable at the second end thereof to an opposite side of the sleeve and spans the bottom first opening of the sleeve in securing a beverage bottle within the sleeve. One or more magnets are incorporated into the structure of the securement member or sleeve to provide for removable attachment of the bottle holder to a metal surface.

US Publication No. 20060201956, incorporated by reference herein, discloses a magnetized insulator for beverage container. An insulator for holding a beverage container against a surface is a shell having an elastomeric wall. The top portion of the insulator includes an opening leading to an interior portion of the insulator. The insulator wall includes at least one magnetic strip. A beverage container is held within the interior of the insulator. The insulator and retained beverage container may then be attached to any metallic surface. The insulator may include retaining straps to more securely hold the beverage container within the interior of the insulator.

US Publication No. 20060124526, incorporated by reference herein, discloses an apparatus for treating a liquid includes a container containing a liquid and a magnetic treatment device therefor. The magnetic treatment device may include an elastic band removably fastened around the container and urged thereagainst by elastic deformation of the elastic band, the elastic band being deformable to accommodate containers having different sizes. The magnetic treatment device may also include at least one permanent magnet carried by the elastic band for magnetically treating the liquid in the container. Alternately, the magnetic treatment device may include a band with a joint therein or a drawstring removably fastened around the container.

US Publication No. 20060102544, incorporated by reference herein, discloses a fluid magnetization device includes a first box and a second box, a pair of permanent magnets and a washer. The second box and the washer are sized to be inserted into the first box, and the permanent magnets are sized to be inserted into the second box and the washer, respectively. The first box and the second box engage with a pipeline. The magnetic field caused by the two permanent magnets magnetizes the fluid flowing the pipeline.

US Publication No. 20030226447, incorporated by reference herein, discloses a beverage flavor enhancing device for use with a beverage container includes a base and a plurality of tubular members extending upwardly from the base and arranged in spaced-apart relation to receive the beverage container therebetween when the beverage container is positioned on the base. At least one permanent magnet is carried by each of the tubular members to generate a magnetic field within the beverage container to thereby enhance the beverage flavor.

Neoprene

Neoprene sheet is a black colored rubber which is used where moderate oil, petroleum, ozone and weathering-resistance is needed. It is very popular due tot eh broad range of applications in which it m ay be used. Neoprene compound may be a blend of SBR (Styrene Butadiene Rubber), CR (Neoprene) and BR (Nitrile rubbers). Neoprene provides excellent resistance to hydrogen gas, natural gas, Salt/Sea Water, Butanol (primary), Acetic Acids (up to 20%), ammonium Salts, Mineral Oils, silicone Oils and Greases, and many more. Neoprene is generally flexible, and may have a medium durometer (55-65), and in sheet form offers moderate pliability and elasticity. In addition to h and fabrication, the product can be fabricated using laser, die and water-jet cut. (Ref: Rubber-Cal Inc., Santa Ana, Calif.)

Neodymium

A neodymium magnet or NIB magnet (also, but less specifically, called a rare-earth magnet) is a powerful magnet made of a combination of neodymium, iron, and boron —Nd2Fe14B. Neodymium magnets are very strong in comparison to their mass, but are also mechanically fragile and the most powerful grades lose their magnetism at temperatures above 80 degrees Celsius (176 degrees Fahrenheit). High-temperature grades will operate at up to 200 and even 230° C. but their strength is only marginally greater than that of samarium-cobalt. Neodymium magnets should always be handled carefully. Some that are slightly larger than the size of a penny are powerful enough to lift over 10 kilograms. Strong magnetic fields can disrupt the operation of some internal medical devices such as pacemakers. While most solid state electronic devices are not affected by magnetic fields, some medical devices are not manufactured to mitigate the effects of strong magnetic fields. These design flaws can be hazardous to patients using these devices. If swallowed, neodymium magnets can cause lethal conditions by joining up inside the intestine. Neodymium magnets are commercially available in various forms, such as in disc or cylindrical form, from various suppliers.

### BRIEF DESCRIPTION (SUMMARY) OF THE INVENTION

It is an object of the invention to provide an improved technique for influencing a fluid, such as a beverage for human (or animal) consumption, with magnetism. Some may refer to this as “magnetically charging” a fluid. The fluid may, for example, be any bottled beverage such as water or wine. Or, simply tap water.

Additionally, it is within the scope of this invention that the fluids may be a cleaning fluid, for example, soap, detergent, bleach, or the like.

Other such fluids are contemplated by this invention, and are included for treatment by this method.

According to the invention, generally, a magnet is applied to the bottom of a fluid bottle etc. for treatment of fluids. The magnet acts on the fluid by rearranging the fluid particles from a random state to a more linear and permeable state that will increase the body's ability to absorb them. The magnet can impose either a positive charge or a negative charge by inverting the magnet.

According to the invention, generally, a magnet such as a disc magnet is built into a vessel such as a cup or a bottle holder or a cup holder, or bowl, etc.), for the treatment of fluids in the cup, or fluid in a bottle in the bottle holder, or fluid in a cup held by the cup holder, or fluid in the bowl, etc.

Most prior art methods involve strapping of magnets to a bottle or vessel.

Modern disc magnets, such as neodymium are small and powerful, and can be built into the vessel. This enables treating the fluid contained in the vessel more quickly and more efficiently. In some embodiments, the magnet can be oriented in either of two orientations—north pole up, or south pole up—which may be referred to herein as “negative” or “positive”.

Magnetic discs can easily be manufactured into the vessel/container of fluid with negative or positive field of magnet treating the fluid/water.

External adhesive may be used, or heat transfer to melt magnet into position.

The invention disclosed herein magnetically “charges” the water molecules, such as for health benefits.

The use of rare earth neodymium-iron-boron disc magnets for any liquid, mainly drinking water, such as mineral (vitamin) water. Also may be used with other products to increase efficiency, such as cleaning products.

It is also within the scope of the invention that the vessel may have either an open or closed top. A closed vessel top is not depicted in the patent drawings. Other objects, features and advantages of the invention may become apparent in light of the following description thereof.

### BRIEF DESCRIPTION OF THE DRAWINGS

Reference will be made in detail to embodiments of the disclosure, examples of which may be illustrated in the accompanying drawing figures (FIGs). The figures are intended to be illustrative, not limiting. Although the invention is generally described in the context of these embodiments, it should be understood that it is not intended to limit the invention to these particular embodiments.

Certain elements in selected ones of the figures may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity. In some cases, hidden lines may be drawn as dashed lines (this is conventional), but in other cases they may be drawn as solid lines.

If shading or cross-hatching is used, it is intended to be of use in distinguishing one element from another (such as a cross-hatched element from a neighboring un-shaded element. It should be understood that it is not intended to limit the disclosure due to shading or cross-hatching in the drawing figures.

Elements of the figures may (or may not) be numbered as follows. The most significant digits (hundreds) of the reference number correspond to the figure number. For example, elements of FIG. 1 are typically numbered in the range of 100-199, and elements of FIG. 2 are typically numbered in the range of 200-299. Similar elements throughout the figures may be referred to by similar reference numerals. For example, the element 199 in FIG. 1 may be similar (and possibly identical) to the element 299 in FIG. 2. Throughout the figures, each of a plurality of elements 199 may be referred to individually as 199a, 199b, 199c, etc. Such relationships, if any, between similar elements in the same or different figures will become apparent throughout the specification, including, if applicable, in the claims and abstract.

FIG. 1 is a perspective view of a vessel for magnetically treating a liquid, according to an embodiment of the invention.

FIG. 1A is a cross-sectional view of a portion of a vessel, such as the vessel shown in FIG. 1, according to the invention.

FIG. 1A is a cross-sectional view of a portion of a vessel, such as the vessel shown in FIG. 1, according to the invention.

FIG. 2 is a perspective view of a vessel in the form of a cup, according to an embodiment of the invention.

### DETAILED DESCRIPTION OF THE INVENTION

Although various features of the invention may be described in the context of a single embodiment, the features may also be provided separately or in any suitable combination. Conversely, although the invention may be described herein in the context of separate embodiments for clarity, the invention may also be implemented in a single embodiment. Furthermore, it should be understood that the invention can be carried out or practiced in various ways, and that the invention can be implemented in embodiments other than the exemplary ones described herein below. The descriptions, examples, methods and materials presented in the in the description, as well as in the claims, should not be construed as limiting, but rather as illustrative.

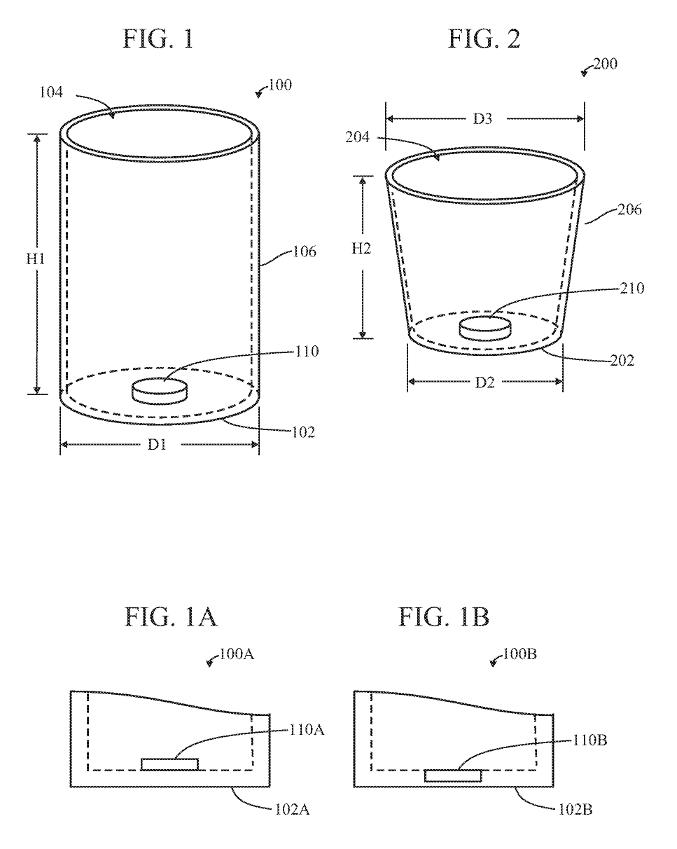

FIG. 1 illustrates a vessel 100, which may be sized and shaped to be suitable for holding a bottle, such as a 16 ounce (half liter) or 32 ounce (or 1 liter) bottle of a beverage such as mineral water, or soda pop, or a bottle of wine, or the like. The vessel 100 may be referred to as a “holder”, or a “beverage holder”.

The vessel 100 is generally cylindrical, having a height “H1” dimension and a diameter “D1” dimension. The vessel 100 is closed by a generally planar wall at its bottom end 102, and open at its top end 104. A generally cylindrical sidewall 106 extends between the top and bottom ends of the vessel. The sidewall 106 has a thickness, which is suitably the thickness of the material forming the vessel. The bottom end wall 102 may have a thickness substantially equal to the sidewall thickness, which is also the thickness of the material forming the vessel. The opening at the top end 104 of the vessel 100 is for receiving a fluid container, such as a beverage bottle (not shown), beer can (not shown), or the like.

The vessel 100 may be formed of plastic, glass, metal or neoprene. Neoprene may be selected, for example, for its insulative qualities, both to keep a beverage cool (in its container) and to make it more comfortable to hold a container with a very cold beverage, such as a cold beer can.

A magnet 110, such as neodymium magnet in the form of a disc, is disposed at the bottom of the vessel 100. The magnet 110 may be oriented with its north pole facing up, or with its south pole facing up. If the magnet is permanently installed, this orientation may be determined at manufacture. If the magnet can be removed and replaced, its orientation can be changed, as desired, by an end user. The magnet is shown with solid lines, although it is obscured by the sidewall 106 and would normally be drawn with dashed lines.

In FIG. 1A, the magnet 110A is shown disposed on an interior surface of the bottom wall 102A of the vessel 100A. The magnet 110A may be secured with a suitable adhesive to the interior surface of the bottom wall 102A. Alternatively, the magnet may be secured to the exterior surface of the bottom wall, which may be formed to accommodate (receive) the magnet. Alternatively, the magnet may be disposed on the inside surface of the bottom wall, and a ferrous piece of material may be disposed on the outside surface of the bottom wall, or embedded in the wall, so that the magnet releasably stays in place, in which case, the magnet may be removed, reoriented (flipped over), and replaced by an end-user.

In FIG. 1B, the magnet 110B is shown recessed into the bottom wall 102B of the vessel 100B. The magnet 110B is at least partially recessed into the bottom wall 102B, including fully recessed. As illustrated, the magnet 110B is recessed into the interior surface of the bottom wall of the vessel. The magnet 110B may also be recessed into the external surface of the bottom wall of the vessel. The magnet 110B may be secured in the recess with a suitable adhesive. Or, it may stay in place with an interference fit, in which case it may be removed, reoriented (flipped over), and replaced by an end-user. Since this is a vessel for a beverage which is in its own container (not shown), the recess for receiving the magnet may extend completely through the bottom wall of the vessel, without concern for water-tightness.

In both cases (FIGS. 1A and 1B), the magnet 110A or 110B may have a diameter which is less than the diameter of the vessel, so that it fits inside the vessel. (In the case of an externally mounted magnet, the magnet may, of course, have a diameter larger than the diameter of the vessel. The magnet may also be ring-shaped, for example.)

Some embodiments of vessels which are beverage container holders are now described.

### Embodiment #1—Bottle Holder

This embodiment can be used as a bottle holder, such as for water or wine bottles, and is suitable for outdoor use.

Structure: cylindrical, open at top end, closed at bottom end

Material: Neoprene cooler material (also serves to insulate the contents of the bottle)

Height approximately 5″ (10-15 cm)

Diameter approximately 3″ (5-10 cm)

Thickness of neoprene is 1/16 to ⅛ inches.

Disc magnet disposed in bottom of bottle holder.

Disc Magnet diameter from about 1″ to about 2″, oriented with either North or South pole upwards.

### Embodiment #2—Cup Holder

This embodiment can be used as a cup holder, or as a small (12-16 ounce) bottle holder, suitable for use in an automobile.

Structure: cylindrical, open at top end, closed at bottom end

Material: Plastic, rigid.

Height approximately 3.5″ (8-12 cm)

Diameter approximately 2-3″ (4-10 cm)

Thickness of plastic: 0.1 mm to 0.3 mm.

Disc magnet disposed in bottom of cup holder.

Disc Magnet diameter from about 1″ to about 2″, oriented with either North or South pole upwards.

FIG. 2 illustrates a vessel 200, which may be sized and shaped to function as a drinking cup (rather than as a holder for holding beverage container, as described above).

The vessel 200 is generally frustro-conical, having a height “H2” dimension, a first diameter “D2” dimension at a bottom end 202 (compare 102) and a second diameter “D3” at a top end 204 (compare 104). Generally, the diameter “D3” at the top end 204 is greater than the diameter “D2” at the bottom end 202. As used herein, although frustro-conical implies tapered, the vessel 200 may yet be considered to be “generally cylindrical”.

The vessel 200 may be considered, generically, to also be a “holder” of fluid, whereas the previously-described vessel 100 was described as a holder for another vessel, such as a beverage container. The vessel 200 may simply be referred to as a “cup”.

The cup 200 is closed by a wall at its bottom end 202, and open at its top end 204. A tapered cylindrical sidewall 206 extends between the top and bottom ends of the cup. The sidewall 206 has a thickness, which is suitably the thickness of the material forming the cup 200. The bottom end wall 202 may have a thickness substantially equal to the sidewall thickness, which is also the thickness of the material forming the cup 200. The opening at the top end 204 of the cup 200 is for receiving a fluid, such as a beverage, water, or the like.

The cup 200 may be formed of plastic, relatively rigid so that it can be held with deforming significantly.

A magnet 210 (compare 110), such as neodymium magnet in the form of a disc, is disposed at the bottom of the cup 200. The magnet 210 may be oriented with its north pole facing up, or with its south pole facing up. If the magnet is permanently installed, this orientation is determined at manufacture. If the magnet can be removed and replaced, its orientation can be changed, as desired, by an end user. The magnet is shown with solid lines, although it is obscured by the sidewall 206 and would normally be drawn with dashed lines.

In a manner similar to what was described hereinabove (with respect to FIGS. 1A and 1B), the magnet 210 may be secured with a suitable adhesive to the interior surface of the bottom wall 202 of the cup 200. Alternatively, the magnet may be secured to the exterior surface of the bottom wall, which may be formed to accommodate (receive) the magnet. Or, the magnet 210 may recessed into the bottom wall of the cup 200, either from the inside (interior) or the outside (exterior). The magnet 210 may be secured in the recess with a suitable adhesive. Or, it may stay in place with an interference fit, in which case it may be removed, reoriented (flipped over), and replaced. In both cases, the magnet 210 may have a diameter which is less than the diameter of the cup 200, so that it fits inside the cup 200.

The cup 200 may have other than a frustro-conical or cylindrical shape. It may be substantially square in cross-section, for example.

An embodiment of a cup (drinking cup) is now described.

### Embodiment #3—Drinking Cup

This embodiment can be used as a drinking cup, or as a small (12-16 ounce) bottle holder, suitable for home use (or camping).

Structure: substantially cylindrical, open at top end, closed at bottom end

Material: Plastic, rigid.

Height “H2” approximately 6″ (15-20 cm)

Diameter “D3” at top (open end) approximately 3-4″ (7-10 cm)

Diameter “D2” at bottom (closed end) approximately 2-3″ (5-7 cm)

Thickness of plastic: 0.1 mm to 0.3 mm.

Disc magnet disposed in bottom of bottle holder.

Disc Magnet diameter 1″-2″, oriented with either North or South pole upwards.

While the invention has been described with respect to a limited number of embodiments, these should not be construed as limitations on the scope of the invention, but rather as examples of some of the embodiments.

Those skilled in the art may envision other possible variations, modifications, and implementations that are also within the scope of the invention, based on the disclosure set forth herein.

What is claimed is:

1. A vessel for magnetically treating a fluid comprising:
a generally cylindrical vessel having an open end and a bottom end closed by a wall; and
a magnet disposed at the bottom wall of the vessel.

2. The vessel of claim 1, wherein:
the fluid is a beverage in a container such as a bottle or a can; and
the container fits into the open top end of the vessel.

3. The vessel of claim 1, wherein:
the vessel is formed of plastic.

4. The vessel of claim 1, wherein:
the vessel is formed of neoprene.

5. The vessel of claim 1, wherein:
the magnet comprises a neodymium magnet.

6. The vessel of claim 1, wherein:
the magnet is in the form of a disc.

7. The vessel of claim 1, wherein:
the magnet is disposed in the vessel with its north pole facing up.

8. The vessel of claim 1, wherein:
the magnet is removable so that its orientation can be changed.

9. The vessel of claim 1, wherein:
the magnet is disposed on an interior surface of a bottom wall of the vessel.

10. The vessel of claim 1, wherein:
the magnet is secured to an interior or exterior surface of the bottom wall.

11. The vessel of claim 1, wherein:
the magnet is embedded in the bottom wall.

12. The vessel of claim 1, wherein:
the magnet is at least partially recessed into the bottom wall.

13. The vessel of claim 1, wherein:
the magnet is fully recessed into the bottom wall.

14. The vessel of claim 1, wherein:
the magnet has a diameter which is less than a diameter of the vessel.

15. The vessel of claim 1, wherein:
the magnet is ring shaped.

16. The vessel of claim 1, wherein:
the vessel is adapted to be used as a bottle holder, such as for water or wine bottles, and is suitable for outdoor use.

17. The vessel of claim 1, wherein:
the vessel is adapted to be used as a cup holder.

18. The vessel of claim 1, wherein:
the vessel is adapted to function as a drinking cup.

19. The vessel of claim 1, wherein:
the vessel is frustro-conical, having a diameter at its top end which is greater than a diameter at its bottom end.

20. The vessel of claim 1, wherein:
the vessel is adapted to hold a fluid.
